(19) United States
(12) Patent Application Publication
(10) Pub. No.: US 2019/0193722 A1
(43) Pub. Date: Jun. 27, 2019

(54) VEHICLE CONTROL APPARATUS AND VEHICLE CONTROL SYSTEM

(71) Applicants: Toyota Jidosha Kabushiki Kaisha, Toyota-shi Aichi-ken (JP); DENSO CORPORATION, Kariya-city (JP)

(72) Inventors: Naoki Yamamuro, Nagoya-shi (JP); Shinichi Adachi, Kariya-shi (JP); Ryo Hattori, Kariya-shi (JP); Taichi Amakasu, Toyota-shi (JP); Keigo Hiruma, Kariya-shi (JP)

(21) Appl. No.: 16/232,374

(22) Filed: Dec. 26, 2018

(30) Foreign Application Priority Data
Dec. 27, 2017 (JP) 2017-252141

(51) Int. Cl. B60W 30/02; B60W 10/04; B60W 10/22; G05D 1/00

(52) U.S. Cl. CPC B60W 30/02; B60W 10/04; B60W 10/22; G05D 1/0088; B60W 30/025; B60G 17/0155; B60W 2400/00; B60W 2710/226; B60W 2720/106; B60W 2720/125; G05D 2201/0213; B60W 2300/12

(57) ABSTRACT

The present disclosure realizes the transport quality and the transport cost corresponding to the way of use of a vehicle. The present disclosure resides in a vehicle control apparatus for attenuating the vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle, approaches a target acceleration. The control apparatus acquires the way of use of the vehicle to set the target acceleration on the basis of the acquired way of use of the vehicle. Then, the control apparatus adjusts the parameter that affects the predetermined acceleration on the basis of the target acceleration.

### CROSS REFERENCE TO RELATED APPLICATIONS

This application claims the benefit of Japanese Patent Application No. 2017-252141, filed on Dec. 27, 2017, which is hereby incorporated by reference herein in its entirety.

### BACKGROUND

### Technical Field

The present disclosure relates to a vehicle control apparatus for a vehicle for transporting people and articles. In particular, the present disclosure relates to a technique for attenuating the vibration of the vehicle.

### Description of the Related Art

In relation to the vehicle such as an automobile or the like for transporting people and articles, such a technique is known that the vibration of the vehicle is attenuated and thus the transport quality represented by the riding comfort is improved by adjusting the parameter which affects the predetermined acceleration including at least one of the acceleration in the upward-downward direction of the vehicle, the acceleration in the lateral direction of the vehicle, and the acceleration in the front-back direction of the vehicle, such as the damping force characteristic of a damper concerning a suspension, the roll stiffness of a stabilizer, the response characteristic of a steering, the rate of change of the vehicle speed or the like. For example, Japanese Patent Application Laid-Open No. 2010-241422 suggests an active type suspension system in which the vibration is attenuated by detecting any undesired vibration of a wheel and/or a vehicle body which may be generated by the variation of the spring stiffness of an air suspension, and adjusting the damping force characteristic of the air suspension depending on the detected vibration.

### SUMMARY

In recent years, it is investigated that one vehicle is utilized for multiple uses (ways of use). In accordance therewith, it is also investigated to develop a vehicle in which the specification such as the inner and outer package or the like can be easily changed depending on the way of use. As for the way of use of such a vehicle, for example, the way of use as the staying type moving vehicle is also conceived, in which the function as the moving vehicle and the function as the staying place for passengers such as the hotel, the workplace or the like are provided in combination, in addition to the way of use as the moving vehicle merely having the purpose of moving people (passengers) and/or articles (cargoes).

In the meantime, assuming that the vehicle is used as the staying type moving vehicle as described above, it is desired that the predetermined acceleration described above is suppressed to be small as far as possible so that the transport quality is raised or enhanced thereby as much as possible. However, if it is intended that the predetermined acceleration described above is suppressed to be small in the active type suspension system as described above, it is necessary that the vibration in which the predetermined acceleration is relatively small should be also attenuated in addition to the vibration in which the predetermined acceleration is relatively large. In association therewith, it is necessary to repeatedly execute, in a short cycle, the detecting process for detecting the predetermined acceleration and the changing process for changing the damping force characteristic on the basis of the detected predetermined acceleration. As a result, the number of times of the operation per unit time is increased for the actuator which is provided to change the damping force characteristic of the suspension. The fuel efficiency or the electricity efficiency of the vehicle is easily deteriorated. If the fuel efficiency or the electricity efficiency of the vehicle is deteriorated for the reason as described above, then the cruising distance of the vehicle is shortened, and hence the transport cost is increased. Therefore, for example, if the damping force characteristic of the suspension is controlled while attaching importance to the transport quality, in the same manner as in the case in which the vehicle is used as the staying type moving vehicle as described above, when the vehicle is used for the way of use in which importance is attached to the transport cost as compared with the transport quality, for example, when the vehicle is used as the moving vehicle, then there is a possibility that the transport cost may be unnecessarily raised on account of the decrease in the cruising distance.

The present disclosure has been made taking the various actual circumstances as described above into consideration, an object of which is to provide a technique that makes it possible to realize the transport quality and the transport cost corresponding to the way of use of a vehicle when one vehicle is used for various ways of use with a vehicle control apparatus for attenuating the vibration of the vehicle by adjusting a parameter which affects a predetermined acceleration including at least one of an upward-downward acceleration, a lateral acceleration, and a front-back acceleration of the vehicle.

In the present disclosure, in order to solve the problem as described above, the target acceleration is changed depending on the way of use of the vehicle when the vehicle is used for various ways of use, with the vehicle control apparatus for attenuating the vibration of the vehicle by adjusting the parameter which affects the predetermined acceleration so that the predetermined acceleration including at least one of the acceleration in the upward-downward direction of the vehicle, the acceleration in the lateral direction of the vehicle, and the acceleration in the front-back direction of the vehicle approaches the target acceleration.

In particular, the present disclosure resides in a vehicle control apparatus which is applicable to a vehicle used for multiple uses (ways of use) and which attenuates vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle when a person (passenger) or an article (cargo) is transported by the vehicle, approaches the target acceleration. The control apparatus acquires a way of use of the vehicle, and sets the target acceleration on the basis of the acquired way of use. Then, the control apparatus adjusts the parameter which affects the predetermined acceleration, on the basis of the target acceleration.

The vehicle, to which the present disclosure is applied, is the vehicle for which the specification such as the inner and outer package or the like can be changed depending on the use (way of use). Those assumed as the way of use of the vehicle referred to herein include, for example, the way of use as the staying type moving vehicle having, in combination, the function of the moving vehicle and the function as the staying place such as a hotel, a workspace or the like, in addition to the way of use as the moving vehicle having the exclusive purpose of transporting cargoes and/or passengers such as a bus, a taxi, a vehicle for collection and delivery or the like. When the vehicle is used for various ways of use as described above, the transport quality and the transport cost, which are required when passengers and/or cargoes are transported, differ depending on the way of use. For example, when the vehicle is used as the staying type moving vehicle as described above, it is required to raise the transport quality by raising the comfort of the passenger. On the other hand, when the vehicle is used as the simple moving vehicle, it is required to lower the transport cost in order to mitigate the monetary burden of the client of the cargo and/or the passenger. In this context, if the target acceleration is set to be small in the configuration in which the vibration of the vehicle is attenuated by adjusting the parameter that affects the predetermined acceleration so that the predetermined acceleration approaches the target acceleration, it is possible to raise the vibration control performance of the vehicle, as compared with if the target acceleration is set to be large. Therefore, in this case, it is possible to raise the transport quality, while there is a possibility that the deterioration of the fuel efficiency and/or the electricity efficiency may be caused. Therefore, there is a possibility that the transport cost may be increased. In view of the above, in the vehicle control apparatus according to the present disclosure, the way of use of the vehicle is acquired, and the target acceleration is set corresponding to the acquired way of use. Accordingly, the parameter, which affects the predetermined acceleration, is adjusted on the basis of the target acceleration adequate for the way of use of the vehicle. As a result, it is possible to realize the transport quality and the transport cost corresponding to the way of use of the vehicle.

In this context, the control apparatus according to the present disclosure may set the target acceleration so that the predetermined acceleration is suppressed to be smaller if the way of use of the vehicle is a way of use in which transport quality is more preferential than transport cost, as compared with a way of use in which the transport cost is more preferential than the transport quality. According to the configuration as described above, if the vehicle is used for the way of use in which the transport quality is more preferential than the transport cost, the vibration, in which the predetermined acceleration is relatively small, is also attenuated, in addition to the vibration in which the predetermined acceleration is relatively large. Therefore, it is possible to raise the vibration control performance of the vehicle. Thus, it is possible to raise the transport quality. On the other hand, if the vehicle is used for the way of use in which the transport cost is more preferential than the transport quality, the vibration, in which the predetermined acceleration is relatively large, is attenuated, while the vibration, in which the predetermined acceleration is relatively small, is not attenuated. Therefore, the deterioration of the fuel efficiency or the electricity efficiency, which is caused by the attenuation of the vibration of the vehicle, can be suppressed to be small. Accordingly, the decrease in the cruising distance of the vehicle can be suppressed to be small, and hence the transport cost can be also suppressed to be small.

Note that when the vehicle is used for the way of use in which the passenger is transported, of the ways of use in which the priority is given to the transport cost, the target acceleration may be set so that the predetermined acceleration is suppressed to be smaller, as compared with when the vehicle is used for the way of use in which the cargo is transported. If the target acceleration is set as described above, then the necessary and minimum comfort can be secured for the passenger when the passenger is transported, and the transport cost, which is required when the cargo is transported, can be suppressed to be smaller.

The present disclosure can be also grasped as a vehicle control system configured to include a vibration control apparatus which is carried on a vehicle, and a server apparatus which is installed outside the vehicle. In this case, the vehicle control system according to the present disclosure may comprise a vibration control apparatus which is carried on a vehicle used for multiple uses (ways of use) and which attenuates vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle when a person (passenger) or an article (cargo) is transported by the vehicle, approaches a target acceleration, and a server apparatus which acquires a way of use of the vehicle, which sets the target acceleration on the basis of the acquired way of use of the vehicle, and which transmits the set target acceleration to the vibration control apparatus. According to the vehicle control system configured as described above, the transport quality and the transport cost, which correspond to the way of use of the vehicle, can be realized, in the same manner as the vehicle control apparatus described above. Further, the setting process for setting the target acceleration, which corresponds to the way of use of the vehicle, is performed by the server apparatus which is installed outside the vehicle, and thus it is possible to reduce, for example, the calculation load exerted on the vibration control apparatus. Accordingly, even when the way of use of the vehicle is diversified, the target acceleration, which is adequate for the individual way of use, can be easily set.

In this context, the vehicle control system described above is useful when the vehicle is a vehicle capable of the autonomous traveling. That is, the vehicle may further comprise an operation control apparatus which allows the vehicle to perform autonomous traveling in accordance with a predetermined operation command. Then, the server apparatus may generate the operation command on the basis of the way of use of the vehicle to transmit the generated operation command to the operation control apparatus.

According to the present disclosure, when one vehicle is used for various uses (ways of use) with the vehicle control apparatus for attenuating the vibration of the vehicle by adjusting the parameter that affects the predetermined acceleration including at least one of the upward-downward acceleration of the vehicle, the lateral acceleration, and the front-back acceleration, it is possible to realize the transport quality and/or the transport cost corresponding to the way of use of the vehicle.

Further features of the present disclosure will become apparent from the following description of exemplary embodiments with reference to the attached drawings.

### BRIEF DESCRIPTION OF DRAWINGS

FIG. 1 indicates an outline of a moving body system to which the present disclosure is applied.

FIG. 2 indicates a block diagram schematically illustrating exemplary constitutive components possessed by the moving body system.

FIG. 3 exemplifies the table configuration of the vehicle information stored in a storage unit of a server apparatus.

FIG. 4 exemplifies the table configuration of the target acceleration information stored in the storage unit of the server apparatus.

FIG. 5 indicates a flow diagram illustrating the flow of the data and the process performed between the respective constitutive components of the moving body system according to the embodiment of the present disclosure.

### DESCRIPTION OF EMBODIMENTS

An explanation will be made below on the basis of the drawings about specified embodiments of the present disclosure. For example, the dimension or size, the material, the shape, and the relative arrangement of constitutive parts or components described in the embodiments of the present disclosure are not intended to limit the technical scope of the disclosure only thereto unless specifically noted.

### (System Outline)

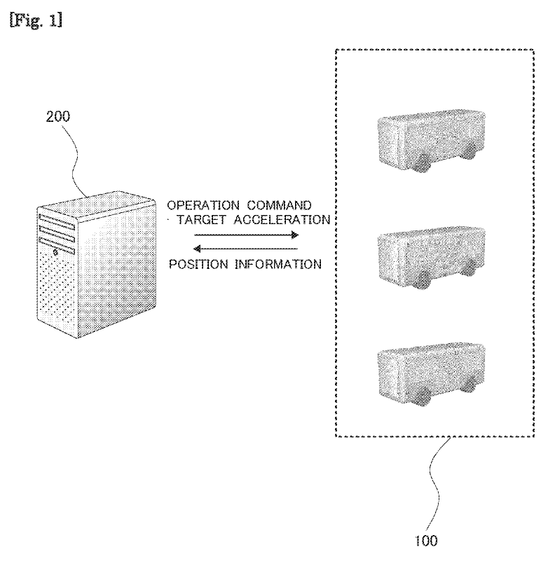

In this embodiment, an example will be described, in which the present disclosure is applied to vehicles as moving bodies in a moving body system including a plurality of moving bodes capable of performing the autonomous traveling. FIG. 1 indicates an outline of a moving body system according to this embodiment. The moving body system shown in FIG. 1 is configured to include a plurality of autonomous traveling vehicles 100 which perform the autonomous traveling in accordance with provided operation commands, and a server apparatus 200 which issues the operation commands to the respective autonomous traveling vehicles 100. The autonomous traveling vehicle 100 is an automatic driving vehicle which provides predetermined service. On the other hand, the server apparatus 200 is an apparatus which manages the plurality of autonomous traveling vehicles 100.

Each of the autonomous traveling vehicles 100 is a multipurpose moving body in which the specification such as the inner and outer package or the like can be easily changed depending on the use (way of use), the vehicle being capable of performing the autonomous traveling on the road. The autonomous traveling vehicle 100 is, for example, a pickup bus which picks up (welcomes and sends off) customers along with a predetermined route, an on-demand taxi which is operated along with a route corresponding to a request from a customer, a cargo transport vehicle which transports cargoes along with a predetermined route, or a staying type passenger transport vehicle which is operated along with a route corresponding to a request from a customer (for example, a vehicle which is installed with hotel facilities or workspace in the room). When the exclusive purpose of the way of use of the autonomous traveling vehicle 100 is to transport cargoes and passengers, it is possible to transport the cargoes and passengers while being operated along with a predetermined route. On the other hand, when the object (purpose) of the way of use of the autonomous traveling vehicle 100 is the staying and the transport of passengers, it is possible to transport the passengers while allowing the passengers to lodge or work in the room. Note that it is not necessarily indispensable that the autonomous traveling vehicle 100 of this embodiment should be a vehicle on which any person other than passengers does not get. For example, the customer service personnel to perform the customer service for passengers, the security personnel to secure the safety of the autonomous traveling vehicle 100, or the collection and delivery personnel to load and unload cargoes may be accompanied. Further, it is also allowable that the autonomous traveling vehicle 100 is not necessarily a vehicle which can perform the complete autonomous traveling. The autonomous traveling vehicle 100 may be a vehicle for which the driving personnel performs the driving or the assistance for the driving depending on circumstances.

Further, each of the autonomous traveling vehicles 100 also has the function such that the vibration of the autonomous traveling vehicle 100 is attenuated by adjusting the parameter which affects the predetermined acceleration so that the predetermined acceleration, which is generated during the traveling of the autonomous traveling vehicle 100, approaches the target acceleration. The “predetermined acceleration” referred to herein includes, for example, the acceleration in the upward-downward direction of the autonomous traveling vehicle 100, the acceleration in the lateral direction of the autonomous traveling vehicle 100, and the acceleration in the front-back direction of the autonomous traveling vehicle 100. That is, each of the autonomous traveling vehicles 100 adjusts the parameters described above so that the accelerations in the three directions described above approach the target accelerations corresponding thereto respectively. Further, the parameter, which affects the predetermined acceleration as described above, is, for example, the damping force characteristic (damping coefficient or attenuation coefficient) of a damper (shock absorber) attached to the suspension of the autonomous traveling vehicle 100, the spring constant of an air spring attached to the suspension of the autonomous traveling vehicle 100, the roll stiffness of a stabilizer provided to span the left and right wheels of the autonomous traveling vehicle 100, the response characteristic of a steering (for example, the rate of change of the turning velocity of the wheel WH), the vehicle velocity, or the rate of change of the vehicle velocity. Note that in this embodiment, a case will be described, in which the damping force characteristic (damping coefficient or attenuation coefficient) of the damper included in the parameters described above is adjusted.

The server apparatus 200 is an apparatus which commands the respective autonomous traveling vehicles 100 to perform the operation. For example, when the autonomous traveling vehicle 100 is an on-demand taxi, then a request from a user is accepted, and the point for the vehicle to go to pickup the user and the destination point are acquired. After that, an operation command of “transport the person from the departure point to the destination point” is transmitted to the autonomous traveling vehicle 100 having the equipment of the taxi, of the autonomous traveling vehicles traveling in the neighborhood. Accordingly, the autonomous traveling vehicle 100, which receives the operation command from the server apparatus 200, can travel along the route based on the operation command. Note that the operation command not necessarily commands the autonomous traveling vehicle 100 to perform the traveling to connect the departure point and the destination point. For example, the operation command may be “travel to predetermined point to collect and/or deliver cargo” or “stop for a predetermined time at a sightseeing spot existing in the course of predetermined route”. In this way, the operation command may include the action other than the traveling to be performed by the autonomous traveling vehicle 100.

Further, the server apparatus 200 has the function to change the target acceleration described above depending on the way of use of the individual autonomous traveling vehicle 100. For example, when the autonomous traveling vehicle 100 is used for the way of use having the purpose of the staying of the passenger as well in addition to the transport of the passenger (for example, the staying type moving vehicle such as the vehicle provided with hotel facilities, the vehicle provided with the workspace or the like), the target acceleration is set so that the predetermined acceleration of the autonomous traveling vehicle 100 is suppressed to be smaller, as compared with when the autonomous traveling vehicle 100 is used for the way of use having the purpose of only the transport of the cargo and/or passenger (for example, simple moving vehicle including, for example, the pickup bus, the on-demand taxi, and the cargo transport vehicle). Accordingly, when the autonomous traveling vehicle 100 is used as the staying type moving vehicle, the vibration of the autonomous traveling vehicle 100 is suppressed to be smaller, as compared with when the autonomous traveling vehicle 100 is used as the simple moving vehicle. Therefore, it is possible to raise the comfort for the passenger staying in the autonomous traveling vehicle 100.

### (System Configuration)

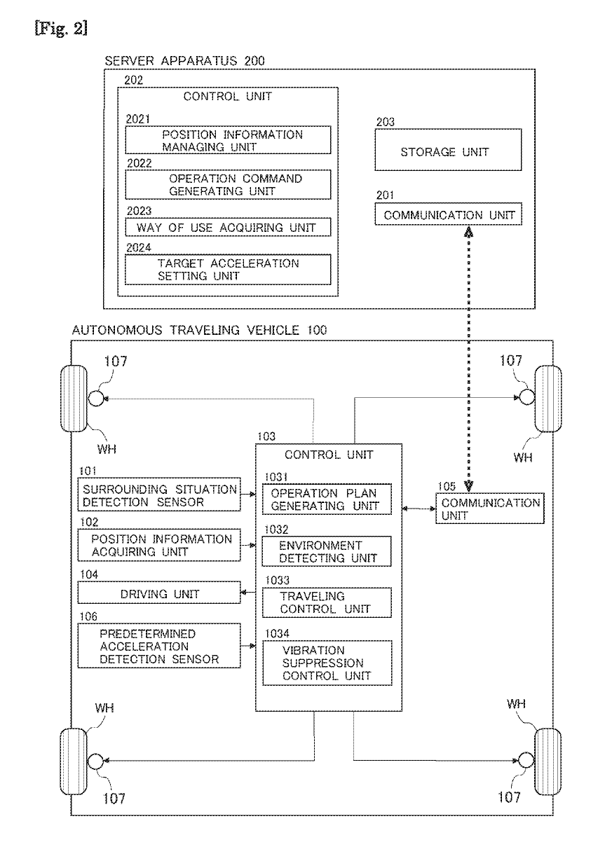

Next, an explanation will be made in detail about the constitutive components of the movement system according to this embodiment. FIG. 2 indicates a block diagram schematically illustrating exemplary configuration of the autonomous traveling vehicle 100 and the server apparatus 200 shown in FIG. 1. Note that a plurality of autonomous traveling vehicles 100 may be provided.

As described above, the autonomous traveling vehicle 100 is the vehicle which travels in accordance with the operation command acquired from the server apparatus 200. Further, the autonomous traveling vehicle 100 also has the function to adjust the damping force characteristic (damping coefficient or attenuation coefficient) during the traveling of the autonomous traveling vehicle 100 on the basis of the target acceleration acquired from the server apparatus 200. The autonomous traveling vehicle 100 as described above is configured to include, for example, a surrounding situation detection sensor 101, a position information acquiring unit 102, a control unit 103, a driving unit 104, a communication unit 105, a predetermined acceleration detection sensor 106, and damper actuators 107. Note that the autonomous traveling vehicle 100 of this embodiment is an electric automobile which is driven by using an electric motor as a motor. The motor of the autonomous traveling vehicle 100 is not limited to the electric motor, which may be an internal combustion engine or a hybrid mechanism composed of an internal combustion engine and an electric motor.

The surrounding situation detection sensor 101 performs the sensing around the vehicle. Typically, the surrounding situation detection sensor 101 is configured to include, for example, a stereo camera, a laser scanner, LIDAR, and a radar. The information, which is acquired by the surrounding situation detection sensor 101, is delivered to the control unit 103.

The position information acquiring unit 102 acquires the present position of the autonomous traveling vehicle 100. Typically, the position information acquiring unit 102 is configured to include, for example, a GPS receiver. Note that the position information acquiring unit 102 acquires the present position of the autonomous traveling vehicle 100 at a predetermined cycle and delivers the information concerning the acquired present position to the control unit 103. In accordance therewith, every time when the control unit 103 accepts the position information from the position information acquiring unit 102, the control unit 103 transmits the position information to the server apparatus 200. In other words, the position information of the autonomous traveling vehicle 100 is transmitted at a predetermined cycle from the autonomous traveling vehicle 100 to the server apparatus 200.

The predetermined acceleration detection sensor 106 is configured to include, for example, an upward-downward acceleration sensor for detecting the acceleration in the upward-downward direction of the autonomous traveling vehicle 100, a lateral acceleration sensor for detecting the acceleration in the lateral direction of the autonomous traveling vehicle 100, and a front-back acceleration sensor for detecting the acceleration in the front-back direction of the autonomous traveling vehicle 100. In this arrangement, the upward-downward acceleration sensor is, for example, a sprung acceleration sensor (spring acceleration sensor) which is attached to a sprung member (for example, a vehicle body) in the vicinity of a suspension of each of wheels WH, and/or an unsprung acceleration sensor (unspring acceleration sensor) which is attached to an unsprung member (for example, a lower arm) in the vicinity of the suspension of each of the wheels WH. The information, which is detected by the predetermined acceleration detection sensor 106, is delivered to the control unit 103.

The damper actuator 107 changes the damping force characteristic (damping coefficient or attenuation coefficient) of a damper (not shown) attached to the suspension of each of the wheels WH. The damping force characteristic of the damper is changed continuously or in a stepwise manner by changing, for example, the cross-sectional area of the flow passage for the viscous fluid (for example, oil) formed in the damper. The damper actuator 107 is operated by the electric power supplied from an unillustrated battery carried on the autonomous traveling vehicle 100. Note that the method for changing the damping force characteristic of the damper is not limited thereto. It is also allowable to use any other known method.

The control unit 103 is a computer which controls the operation of the autonomous traveling vehicle 100 on the basis of the information acquired from the surrounding situation detection sensor 101 and which controls the damper actuator 107 on the basis of the information acquired from the predetermined acceleration detection sensor 106. The control unit 103 is configured, for example, by a microcomputer. The control unit 103 of this embodiment has, as functional modules, an operation plan generating unit 1031, an environment detecting unit 1032, a traveling control unit 1033, and a vibration suppression control unit 1034. The respective functional modules may be realized by executing programs stored in the storage unit such as ROM (Read Only Memory) or the like by CPU (Central Processing Unit) (any of them is not shown).

The operation plan generating unit 1031 acquires the operation command from the server apparatus 200 to generate the operation plan of the subject vehicle. In this embodiment, the operation plan is the data that prescribes the route along which the autonomous traveling vehicle 100 travels and the process which is to be performed by the autonomous traveling vehicle 100 in a part of or all of the route. For example, the followings are exemplified as examples of the data included in the operation plan.

(1) Data in which Route for Allowing Subject Vehicle to Travel Therealong is Represented by Set of Road Links

The “route for allowing the subject vehicle to travel therealong” referred to herein may be generated by the operation plan generating unit 1031, for example, on the basis of the given departure point and the destination point while making reference to the map data stored in the storage apparatus carried on the autonomous traveling vehicle 100. Alternatively, the “route for allowing the subject vehicle to travel therealong” may be generated by utilizing any external service, or it may be provided from the server apparatus 200.

(2) Data which Represents Process to be Performed by Subject Vehicle at Point on Route

The process to be performed by the subject vehicle includes, for example, “allow passengers to get on/off”, “load/unload cargoes”, and “stop for a predetermined period for passenger's sightseeing”. However, there is no limitation thereto.

The environment detecting unit 1032 detects the environment around the vehicle on the basis of the data acquired by the surrounding situation detection sensor 101. The object of the detection is, for example, the number and the position of the lane(s), the number and the position of the vehicle(s) existing around the subject vehicle, the number and the position of the obstacle(s) (for example, pedestrian(s), bicycle(s), structure(s), and building(s)) existing around the subject vehicle, the structure of the road, and the road sign. However, there is no limitation thereto. The detection target may be anyone provided that the object is required to perform the autonomous traveling. Further, the environment detecting unit 1032 may perform the tracking for the detected object. For example, the relative velocity of the object may be determined from the difference between the coordinates of the object detected one step before and the present coordinates of the object.

The traveling control unit 1033 controls the traveling of the subject vehicle on the basis of the operation plan generated by the operation plan generating unit 1031, the environment data generated by the environment detecting unit 1032, and the position information of the subject vehicle acquired by the position information acquiring unit 102. For example, the subject vehicle is allowed to travel so that the subject vehicle travels along a predetermined route and any obstacle does not enter a predetermined safe area provided around the subject vehicle as the center. Note that as for the method for allowing the subject vehicle to perform the autonomous traveling, it is possible to adopt any known method.

The vibration suppression control unit 1034 controls the damper actuator 107 of each of the wheels WH so that the predetermined acceleration described above approaches the target acceleration set by the server apparatus 200 (vibration attenuating process). In the vibration attenuating process, for example, if at least one of the sprung accelerations of the plurality of wheels WH, at least one of the unsprung accelerations of the plurality of wheels WH, the lateral acceleration of the autonomous traveling vehicle 100, or the front-back acceleration of the autonomous traveling vehicle 100 exceeds a predetermined threshold value, then the vibration suppression control unit 1034 individually calculates the damping force characteristic (damping coefficient or attenuation coefficient) of the damper of each of the wheels WH on the basis of the predetermined acceleration acquired by the predetermined acceleration detection sensor 106 (sprung acceleration of each of the wheels WH, unsprung acceleration of each of the wheels WH, lateral acceleration of the autonomous traveling vehicle 100, and front-back acceleration of the autonomous traveling vehicle 100), and the vibration suppression control unit 1034 controls the damper actuator 107 of each of the wheels WH in accordance with the calculated damping force characteristic (damping coefficient or attenuation coefficient). Accordingly, the vibration of the autonomous traveling vehicle 100 (vibration of the body) is attenuated. The “predetermined threshold value” referred to herein is the value which is set while being correlated with the sprung acceleration, the unsprung acceleration, the lateral acceleration, and the front-back acceleration respectively. The “predetermined threshold value” is the value which is changed depending on the target acceleration corresponding to each of the accelerations. For example, the predetermined threshold value of each of the accelerations is set to a small value when the target acceleration corresponding to each of the accelerations is small as compared with when the target acceleration corresponding to each of the accelerations is large. Note that as for the method for calculating the damping force characteristic (damping coefficient or attenuation coefficient) of the damper, it is possible to adopt any known method. Further, the predetermined acceleration is not limited to one which includes all of the sprung acceleration, the unsprung acceleration, the lateral acceleration, and the front-back acceleration. It is enough that the predetermined acceleration includes at least one of them. In accordance therewith, as for the target acceleration and the predetermined threshold value described above, it is also appropriate to set those corresponding to the acceleration component included in the predetermined acceleration.

The driving unit 104 allows the autonomous traveling vehicle 100 to travel on the basis of the command generated by the traveling control unit 1033. The driving unit 104 is configured to include, for example, a motor (for example, an internal combustion engine, an electric motor, or a hybrid mechanism of an internal combustion engine and an electric motor), a braking apparatus, and a steering arrangement (steering gear).

The communication unit 105 connects the autonomous traveling vehicle 100 to the network. In this embodiment, the communication can be performed with any other apparatus (for example, the server apparatus 200) via the network by utilizing the mobile communication service such as 3G (3rd Generation), LTE (Long Term Evolution) or the like. Note that the communication unit 105 may further comprise any communication unit type that performs the inter-vehicle communication with respect to any other autonomous traveling vehicle 100.

Next, the server apparatus 200 will be explained. The server apparatus 200 is the apparatus which manages the traveling positions of the plurality of autonomous traveling vehicles 100 and which transmits the operation commands. Further, the server apparatus 200 also has such a function that the target acceleration described above is set depending on the way of use of the individual autonomous traveling vehicle 100. The server apparatus 200 as described above is configured to have a communication unit 201, a control unit 202, and a storage unit 203. The communication unit 201 is a communication interface for performing the communication with the autonomous traveling vehicle 100 via the network in the same manner as the communication unit 105.

The control unit 202 administers the control of the server apparatus 200. The control unit 202 is configured, for example, by CPU. The control unit 202 of this embodiment has, as functional modules, a position information managing unit 2021, an operation command generating unit 2022, a way of use acquiring unit 2023, and a target acceleration setting unit 2024. These functional modules may be realized by executing programs stored in the storage unit such as ROM or the like by CPU (any of them is not shown).

The position information managing unit 2021 manages the positions of the plurality of autonomous traveling vehicles 100 under the management of the server apparatus 200. Specifically, the position information managing unit 2021 receives the position information from the plurality of autonomous traveling vehicles 100 at every predetermined cycle, and the position information managing unit 2021 stores it in the storage unit 203 as described later on while being correlated with the date and time.

The operation command generating unit 2022 determines the autonomous traveling vehicle 100 to be dispatched when a vehicle allocation request for the autonomous traveling vehicle 100 is received from the outside, and the operation command generating unit 2022 generates the operation command corresponding to the vehicle allocation request. The vehicle allocation request includes, for example, the followings. However, it is also allowable to provide any other request.

### (1) Transport Request for Cargoes and Passengers

This request is to perform the transport of cargoes and passengers by designating the departure point and the destination point, or the visitation route.

### (2) Dispatch Request for Autonomous Traveling Vehicle Having Specified Function in Combination

This request is to ask the dispatch of the autonomous traveling vehicle 100 having the function of, for example, the lodging facilities for passengers (hotel) or the workspace for passengers (for example, private office or business office). As for the dispatch destination, either a single point is available, or a plurality of points are available. If a plurality of dispatch destinations are designated, it is also allowable to provide the service at the plurality of points respectively.

The vehicle allocation request as described above is acquired from the user or customer, for example, via the internet. Note that it is not necessarily indispensable that the transmission source of the vehicle allocation request should be any general user. The transmission source of the vehicle allocation request may be, for example, an entrepreneur who operates the autonomous traveling vehicle 100. The autonomous traveling vehicle 100, which is the transmission destination of the operation command, is determined depending on, for example, the position information of each vehicle acquired by the position information managing unit 2021 and the specification of each vehicle (for what way of use the vehicle has its interior/exterior equipment) previously grasped by the server apparatus 200. Then, if the autonomous traveling vehicle 100, which is the transmission destination of the operation command, is determined, the operation command, which is generated by the operation command generating unit 2022, is transmitted to the autonomous traveling vehicle 100 by the communication unit 201 together with the target acceleration set by the target acceleration setting unit 2024 described later on.

The way of use acquiring unit 2023 acquires the way of use of the autonomous traveling vehicle 100 which is the object of the operation command generated by the operation command generating unit 2022 described above. The way of use of the autonomous traveling vehicle 100 acquired by the way of use acquiring unit 2023 is, for example, the way of use having the purpose of only the transport of cargoes and passengers, the way of use having the purpose of the lodging and the transport of passengers, and the way of use having the purpose of the workspace for passengers and the transport of passengers. However, any other way of use is available as well. Note that the way of use of each of the autonomous traveling vehicles 100 is stored in the storage unit 203 described later on, while being correlated with the information for identifying the autonomous traveling vehicle 100 at the point in time at which the specification of the individual autonomous traveling vehicle 100 is changed. Accordingly, the way of use acquiring unit 2023 can acquire the way of use of the autonomous traveling vehicle 100 by accessing the storage unit 203 on the basis of the identification information of the autonomous traveling vehicle 100 for which it is required to acquire the way of use.

The target acceleration setting unit 2024 sets the target acceleration adequate for the way of use acquired by the way of use acquiring unit 2023. In particular, if the way of use, which is acquired by the way of use acquiring unit 2023, is the way of use having the purpose of the staying and the transport of passengers (for example, the way of use having the purpose of the lodging and the transport of passengers or the way of use having the purpose of the workspace and the transport of passengers), the target acceleration setting unit 2024 sets the target acceleration so that the predetermined acceleration described above is suppressed to be small as far as possible. Accordingly, it is possible to improve the riding comfort for passengers staying in the autonomous traveling vehicle 100.

In this context, if the target acceleration is set so that the predetermined acceleration (sprung acceleration, unsprung acceleration, lateral acceleration, and front-back acceleration) is suppressed to be smaller, the predetermined threshold value described above is also decreased in accordance therewith. Therefore, the number of times of the occurrence of the situation in which the predetermined acceleration exceeds the predetermined threshold value increases with ease. On account thereof, the frequency of the operation of the damper actuator 107 is easily increased. If the frequency of the operation of the damper actuator 107 is increased, then the electric power, which is consumed to operate the damper actuator 107, is increased, and thus the electricity efficiency of the autonomous traveling vehicle 100 is deteriorated. If the electricity efficiency of the autonomous traveling vehicle 100 is deteriorated for the reason as described above, then the cruising distance of the autonomous traveling vehicle 100 is decreased, and hence there is a possibility that the transport cost may be increased for cargoes and passengers. On this account, if the target acceleration, which is equivalent to that provided when the autonomous traveling vehicle 100 is used for the way of use having the purpose of the staying and the transport of the passenger, is set when the autonomous traveling vehicle 100 is used for the way of use having the purpose of only the transport of the cargo and passenger, then the transport cost of the cargo and passenger is unnecessarily increased on account of the decrease in the cruising distance of the autonomous traveling vehicle 100, and thus there is a possibility that the monetary burden of the client of the cargo transport, the passenger or the like may be unnecessarily increased.

In view of the above, in this embodiment, the target acceleration setting unit 2024 sets difference target accelerations depending on the ways of use of the autonomous traveling vehicles 100 respectively. That is, if the way of use of the autonomous traveling vehicle 100 is the way of use in which the priority is given to the transport quality as compared with the transport cost (way of use having the purpose of the staying and the transport of the passenger), the target acceleration is set so that the predetermined acceleration is suppressed to be smaller, as compared with if the way of use of the autonomous traveling vehicle 100 is the way of use in which the priority is given to the transport cost as compared with the transport quality (way of use having the purpose of only the transport of the cargo and passenger). In this way, when the target acceleration is set depending on the way of use of the autonomous traveling vehicle 100, if the autonomous traveling vehicle 100 is used for the way of use in which the priority is given to the transport quality as compared with the transport cost, for example, if the autonomous traveling vehicle 100 is used as the staying type moving vehicle, then the vibration, in which the predetermined acceleration is relatively small, is also attenuated in addition to the vibration in which the predetermined acceleration is relatively large. Therefore, it is possible to raise the comfort for the passenger. On the other hand, if the autonomous traveling vehicle 100 is used for the way of use in which the priority is given to the transport cost as compared with the transport quality, for example, if the autonomous traveling vehicle 100 is used as the simple moving vehicle for cargoes and passengers, then the vibration, in which the predetermined acceleration is relatively large, is attenuated, while the vibration, in which the predetermined acceleration is relatively small, is not attenuated. Therefore, the decrease in the cruising distance, which is caused by the operation of the damper actuator 107, can be suppressed to be small, and thus the monetary burden of the client of the cargo transport, the passenger or the like can be suppressed to be small. Note that the target acceleration as described above is stored in the storage unit 203 described later on while being correlated with each of the ways of use. Accordingly, the target acceleration setting unit 2024 can derive the target acceleration of the autonomous traveling vehicle 100 by accessing the storage unit 203 on the basis of the way of use of the autonomous traveling vehicle 100 for which it is necessary to set the target acceleration.

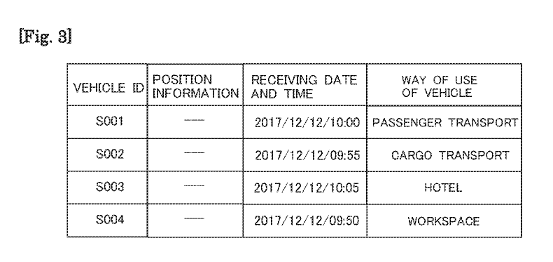

The storage unit 203 stores the information. The storage unit 203 is configured by a storage medium such as RAM, a magnetic disk, a flash memory or the like. The vehicle information concerning the individual autonomous traveling vehicle 100 is stored in the storage unit 203 of this embodiment in which the vehicle information is linked to the identification information of the individual autonomous traveling vehicle 100. An explanation will now be made on the basis of FIG. 3 about exemplary configuration of the vehicle information stored in the storage unit 203. FIG. 3 indicates the table configuration of the vehicle information. The vehicle information table shown in FIG. 3 has respective fields of, for example, the vehicle ID, the position information, the date and time of the receiving, and the way of use of the vehicle. The vehicle identification information, which is provided to identify the individual autonomous traveling vehicle 100, is inputted into the vehicle ID field. The position information, which is received by the position information managing unit 2021 from the individual autonomous traveling vehicle 100, is inputted into the position information field. The position information, which is inputted into the position information field, may be, for example, the information which indicates the address of the place at which the autonomous traveling vehicle 100 is positioned, or the information which indicates the coordinates (latitude, longitude) on a map of the place at which the autonomous traveling vehicle 100 is positioned. The date and time, at which the position information inputted into the position information field described above is received by the position information managing unit 2021 from the autonomous traveling vehicle 100, is inputted into the receiving date and time field. Note that it is assumed that the information, which is inputted into the position information field and the receiving date and time field, is updated every time when the position information managing unit 2021 receives the position information from each of the autonomous traveling vehicles 100 (in the predetermined cycle described above). Then, the information, which indicates the way of use of the autonomous traveling vehicle 100, is inputted into the way of use of vehicle field. For example, if the way of use of the autonomous traveling vehicle 100 is a pickup bus, an on-demand taxi or the like having the purpose to transport the passenger only, “passenger transport” is inputted. If the way of use of the autonomous traveling vehicle 100 is a cargo transport vehicle or the like having the purpose to transport the cargo only, “cargo transport” is inputted. If the way of use of the autonomous traveling vehicle 100 is a staying type transport vehicle having the purpose to lodge and transport the passenger, “hotel” is inputted. If the way of use of the autonomous traveling vehicle 100 is a staying type transport vehicle having the purpose to provide the workspace for the passenger and transport the passenger, “workspace” is inputted. Note that it is assumed that the information, which is inputted into the way of use of vehicle field, is updated every time when the specification of each of the autonomous traveling vehicles 100 is changed.

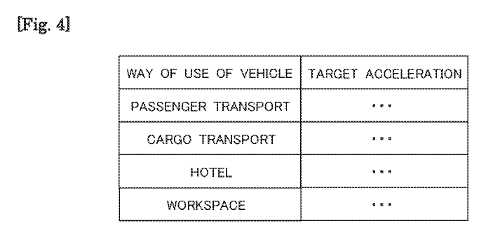

Further, the target acceleration information, in which the way of use of the autonomous traveling vehicle 100 is linked to the target acceleration, is also stored in the storage unit 203. An explanation will now be made on the basis of FIG. 4 about exemplary configuration of the target acceleration information stored in the storage unit 203. FIG. 4 indicates the table configuration of the target acceleration information. The target acceleration information table shown in FIG. 4 has the way of use of vehicle field and the target acceleration field. The information, which indicates the way of use of the autonomous traveling vehicle 100, is inputted into the way of use of vehicle field. The information, which is inputted into the way of use of vehicle field, is the information which is distinguished on the same basis as that of the information which is inputted into the way of use of vehicle field of the vehicle information table shown in FIG. 3 described above. Further, the target acceleration, which is adequate for the way of use of the vehicle, is inputted into the target acceleration field. For example, if the way of use of the vehicle is “passenger transport”, the target acceleration, which is set so that the predetermined acceleration is suppressed to be smaller, is inputted, as compared with if the way of use of the vehicle is “cargo transport”. Then, if the way of use of the vehicle is “hotel” or “workspace”, the target acceleration, which is set so that the predetermined acceleration is suppressed to be smaller, is inputted, as compared with if the way of use of the vehicle is “passenger transport”.

The target acceleration information table shown in FIG. 4 is illustrative of the exemplary case in which the target acceleration corresponding to the way of use of the vehicle is set. However, the target acceleration may be set corresponding to the specifications (for example, size or dimension, weight, wheel base, and tread) of the autonomous traveling vehicle 100 as well in addition to the way of use of the vehicle. For example, even when the way of use of the vehicle is identical, the vibration in the upward-downward direction of the autonomous traveling vehicle 100, the vibration in the lateral direction, and the vibration in the front-back direction are easily increased if the wheel base and/or the tread of the autonomous traveling vehicle 100 used for the way of use is/are small as compared with if the wheel base and/or the tread is/are large. Therefore, the target acceleration may be set so that the predetermined acceleration is suppressed to be smaller. Further, if the transport of the passenger is included in the way of use of the autonomous traveling vehicle 100, for example, if the way of use of the vehicle is, for example, “passenger transport”, “hotel”, or “workspace”, then the target acceleration may be set to have different values between the state in which the passenger does not get on the autonomous traveling vehicle 100 and the state in which the passenger gets on the autonomous traveling vehicle 100, for example, between the situation in which the autonomous traveling vehicle 100 goes to the pickup point and the situation in which the autonomous traveling vehicle 100 returns to the garage or the like from the point at which the passenger gets off the autonomous traveling vehicle 100. For example, the target acceleration may be set so that the predetermined acceleration is suppressed to be smaller in the state in which the passenger gets on the autonomous traveling vehicle 100 as compared with the state in which the passenger does not get on the autonomous traveling vehicle 100. If the target acceleration is set as described above, it is possible to improve the electricity efficiency when the passenger does not get on the autonomous traveling vehicle 100.

Note that the target acceleration, which is inputted into the target acceleration field of the target acceleration information table described above, may be previously determined on the basis of a result of any experiment or simulation. Further, the target acceleration, which is inputted into the target acceleration field described above, may be appropriately updated on the basis of the evaluation of, for example, the passenger who got on the autonomous traveling vehicle 100 when the autonomous traveling vehicle 100 was actually operated.

### (Operation Action of Autonomous Traveling Vehicle)

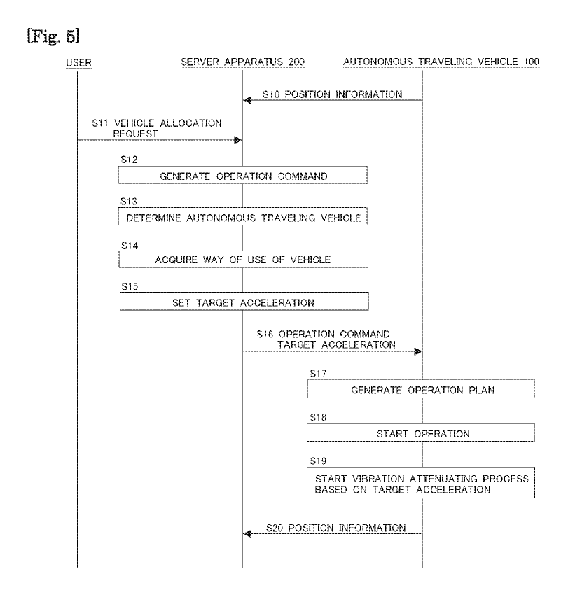

An explanation will now be made about the processes performed by the respective constitutive components described above. FIG. 5 explains the data flow until the autonomous traveling vehicle 100 starts the operation after the server apparatus 200 generates the operation command on the basis of a vehicle allocation request of a user.

Each of the autonomous traveling vehicles 100 notifies the server apparatus 200 of the position information at a predetermined cycle. In this procedure, the signal, which is transmitted from the autonomous traveling vehicle 100 to the server apparatus 200, includes the identification information (vehicle ID) of the autonomous traveling vehicle 100 in addition to the position information of the autonomous traveling vehicle 100. If the position information and the vehicle ID sent from the autonomous traveling vehicle 100 are received by the communication unit 201 of the server apparatus 200 (Step S10), then the position information managing unit 2021 accesses the vehicle information stored in the storage unit 203, and the information of the receiving data and time field and the position information field of the vehicle information table corresponding to the vehicle ID is updated.

If the user transmits the vehicle allocation request to the server apparatus 200 by the aid of unillustrated communication units, the vehicle allocation request is received by the communication unit 201 of the server apparatus 200 (Step S11). In this case, the vehicle allocation request described above also includes the information concerning the purpose of use of the autonomous traveling vehicle 100 (way of use of the vehicle), in addition to the information of, for example, the departure point (pickup point), the destination point (getting off point), the date and time of departure, the preferred date and time of arrival at the destination point, and the transit point (place for passenger to see sights and/or collection and delivery place for cargo).

In Step S12, the operation command generating unit 2022 generates the operation command in accordance with the vehicle allocation request. The operation command may designate the departure point, the destination point, the date and time of departure, the preferred date and time of arrival at the destination point, and the transit point. Alternatively, the operation command may designate the traveling route in addition to the designation of those described above. The operation command may further include the information concerning the process to be performed in the course of the traveling route and the service to be provided.

In Step S13, the operation command generating unit 2022 selects the autonomous traveling vehicle 100 adequate for the way of use of the vehicle included in the vehicle allocation request. For example, the operation command generating unit 2022 firstly makes reference to the vehicle information table of the storage unit 203 to extract all of the autonomous traveling vehicles 100 which have the facilities adequate for the way of use of the vehicle of the vehicle allocation request and which can be operated in the period ranging from the date and time of departure to the preferred date and time of arrival. Subsequently, the operation command generating unit 2022 selects one autonomous traveling vehicle 100 which can be moved to the departure point on the date and time of departure on the basis of the respective pieces of position information of the extracted autonomous traveling vehicles 100. When the autonomous traveling vehicle 100, which follows the vehicle allocation request described above, is selected by the operation command generating unit 2022, the vehicle ID of the selected autonomous traveling vehicle 100 is delivered from the operation command generating unit 2022 to the way of use acquiring unit 2023.

In Step S14, the way of use acquiring unit 2023 accesses the vehicle information table of the storage unit 203 on the basis of the vehicle ID accepted from the operation command generating unit 2022 to thereby acquire the way of use of the vehicle linked to the vehicle ID. The way of use of the vehicle acquired by the way of use acquiring unit 2023 is delivered from the way of use acquiring unit 2023 to the target acceleration setting unit 2024.

In Step S15, the target acceleration setting unit 2024 sets the target acceleration which is adequate for the way of use of the vehicle accepted from the way of use acquiring unit 2023. Specifically, the target acceleration setting unit 2024 accesses the target acceleration information table of the storage unit 203 on the basis of the way of use of the vehicle accepted from the way of use acquiring unit 2023, and thus the target acceleration setting unit 2024 derives the target acceleration linked to the way of use of the vehicle.

In Step S16, the operation command generated by the operation command generating unit 2022 and the target acceleration set by the target acceleration setting unit 2024 are transmitted from the communication unit 201 of the server apparatus 200 to the autonomous traveling vehicle 100 selected by the operation command generating unit 2022.

If the operation command and the target acceleration transmitted from the server apparatus 200 are received by the communication unit 105 of the autonomous traveling vehicle 100, the operation plan generating unit 1031 of the autonomous traveling vehicle 100 generates the operation plan on the basis of the operation command received from the server apparatus 200 (Step S17). The operation plan, which is generated by the operation plan generating unit 1031, is delivered from the operation plan generating unit 1031 to the traveling control unit 1033. Then, the traveling control unit 1033 starts the operation of the autonomous traveling vehicle 100 in accordance with the operation plan accepted from the operation plan generating unit 1031 (Step S18).

When the operation of the autonomous traveling vehicle 100 by the traveling control unit 1033 is started, the vibration suppression control unit 1034 controls the damper actuators 107 of the respective wheels WH so that the predetermined acceleration of the autonomous traveling vehicle 100 approaches the target acceleration received from the server apparatus 200 (Step 19). Specifically, the vibration suppression control unit 1034 firstly determines the predetermined threshold value described above on the basis of the target acceleration received from the server apparatus 200. Subsequently, if at least one of the sprung accelerations of the plurality of wheels WH, at least one of the unsprung accelerations of the plurality of wheels WH, the lateral acceleration of the autonomous traveling vehicle 100, or the front-back acceleration of the autonomous traveling vehicle 100 exceeds the predetermined threshold value described above, then the vibration suppression control unit 1034 individually calculates the damping force characteristic (damping coefficient or attenuation coefficient) of the damper of each of the wheels WH on the basis of the predetermined acceleration acquired by the predetermined acceleration detection sensor 106 (for example, the sprung acceleration of each of the wheels WH, the unsprung acceleration of each of the wheels WH, the lateral acceleration of the autonomous traveling vehicle 100, or the front-back acceleration of the autonomous traveling vehicle 100), and the vibration suppression control unit 1034 controls the damper actuator 107 of each of the wheels WH in accordance with the calculated damping force characteristic (damping coefficient or attenuation coefficient). In this procedure, if the way of use of the autonomous traveling vehicle 100 is the way of use in which the priority is given to the transport quality as compared with the transport cost (staying type moving vehicle), the target acceleration is set so that the predetermined acceleration is suppressed to be smaller, as compared with if the way of use of the autonomous traveling vehicle 100 is the way of use in which the priority is given to the transport cost as compared with the transport quality (simple moving vehicle). Therefore, the vibration, in which the predetermined acceleration is relatively small, is also attenuated, in addition to the vibration in which the predetermined acceleration is relatively large. As a result, it is possible to raise the comfort for the passenger. On the other hand, if the way of use of the autonomous traveling vehicle 100 is the way of use in which the priority is given to the transport cost as compared with the transport quality (simple moving vehicle), then the vibration, in which the predetermined acceleration is relatively large, is attenuated, while the vibration, in which the predetermined acceleration is relatively small, is not attenuated. Therefore, the decrease in the cruising distance, which is caused by the operation of the damper actuator 107, can be suppressed to be small. Thus, the monetary burden of, for example, the client of the cargo transport and/or the passenger can be suppressed to be small.

Note that the transmission of the position information from the autonomous traveling vehicle 100 to the server apparatus 200 is also performed repeatedly at the predetermined cycle even after the start of the operation of the autonomous traveling vehicle 100 (Step S20). Accordingly, the server apparatus 200 can grasp, for example, the position and the operation state of the autonomous traveling vehicle 100 during the operation of the autonomous traveling vehicle 100 as well.

According to the embodiment described above concerning the control apparatus for the vehicle in which the vibration of the autonomous traveling vehicle 100 is attenuated by adjusting the parameter which affects the predetermined acceleration of the autonomous traveling vehicle 100, it is possible to realize the transport quality and the transport cost corresponding to the way of use of the autonomous traveling vehicle 100, when one autonomous traveling vehicle 100 is used for various ways of use.

Note that in this embodiment, the autonomous traveling vehicle is exemplified as the vehicle to which the present disclosure is applied by way of example. However, the present disclosure is also applicable to a vehicle which is driven by manual operation by a driver. In short, the present disclosure can be applied to any vehicle provided that the specification such as the inner and outer package or the like can be easily changed depending on the way of use.

Further, the example, in which the acquiring process for acquiring the way of use and the setting process for setting the target acceleration are performed on the side of the server apparatus, has been described in this embodiment. However, these processes may be performed on the side of the vehicle.

Further, the example, in which the target acceleration is fixed to the value which is set by the server apparatus when the vehicle is used as the staying type moving vehicle, has been described in this embodiment. However, the target acceleration may be appropriately changed depending on the request from the passenger. For example, an input device for inputting the request for changing the riding comfort level (for example, a touch panel capable of displaying a button for inputting the request for the change with respect to the software side and a button for inputting the request for the level change with respect to the hardware side) may be previously installed at the interior of the vehicle. Thus, when the passenger inputs the level change request by using the input device, then the request may be transmitted from the vehicle to the server apparatus, and the target acceleration may be reset by the server apparatus. Then, if the vibration attenuating process is performed on the basis of the reset target acceleration by transmitting the reset target acceleration from the server apparatus to the vehicle, then it is possible to realize the riding comfort corresponding to the preference of the passenger, and it is possible to further raise the degree of satisfaction of the passenger.

Further, the example, in which the predetermined acceleration approaches the target acceleration by controlling one parameter (damping force characteristic (damping coefficient or attenuation coefficient) of the damper) of the plurality of parameters that affect the predetermined acceleration of the vehicle, has been described in this embodiment. However, there is no limitation thereto. The present disclosure is also applicable to the configuration in which the predetermined acceleration approaches the target acceleration by controlling at least two parameters of the plurality of parameters that affect the predetermined acceleration of the vehicle

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A vehicle control apparatus applicable to a vehicle used for multiple ways of use, the vehicle control apparatus comprising:
a controller comprising at least one processor,
the controller configured to:
acquire a way of use of the vehicle;
set a target acceleration which is a target value of a predetermined acceleration including at least one of an acceleration in an upward-downward direction of the vehicle, an acceleration in a lateral direction, and an acceleration in a front-back direction when a person or an article is transported by the vehicle, on the basis of the way of use of the vehicle; and
adjust a parameter which affects the predetermined acceleration so that the predetermined acceleration approaches the target acceleration.

2. The vehicle control apparatus according to claim 1, wherein the controller sets the target acceleration so that the predetermined acceleration is suppressed to be smaller if the way of use of the vehicle is a way of use in which transport quality is more preferential than transport cost, as compared with a way of use in which the transport cost is more preferential than the transport quality.

3. A vehicle control system comprising:
a vibration control apparatus which is carried on a vehicle used for multiple ways of use and which attenuates vibration of the vehicle by adjusting a parameter that affects a predetermined acceleration so that the predetermined acceleration, which includes at least one of an acceleration in an upward-downward direction of the vehicle, an acceleration in a lateral direction, and an acceleration in a front-back direction when a person or an article is transported by the vehicle, approaches a target acceleration; and
a server apparatus which acquires a way of use of the vehicle, which sets the target acceleration on the basis of the acquired way of use of the vehicle, and which transmits the set target acceleration to the vibration control apparatus.

4. The vehicle control system according to claim 3, wherein:
the vehicle further comprises an operation control apparatus which allows the vehicle to perform autonomous traveling in accordance with a predetermined operation command; and
the server apparatus generates the operation command on the basis of the way of use of the vehicle to transmit the generated operation command to the operation control apparatus.
